(19) United States
(12) Patent Application Publication
(10) Pub. No.: US 2026/0160590 A1
(43) Pub. Date: Jun. 11, 2026

(54) METHOD AND SYSTEM FOR SURVEILLANCE OF AN ESTIMATE OF THE GROSS MASS OF AN AIRCRAFT

(71) Applicant: AIRBUS OPERATIONS SAS, Toulouse (FR)

(72) Inventors: Clément SAFON, Toulouse (FR); Nicolas MARTIN, Toulouse (FR); Chaymae KEROUAD, Toulouse (FR)

(73) Assignee: AIRBUS OPERATIONS SAS, Toulouse (FR)

(21) Appl. No.: 19/412,798

(22) Filed: Dec. 8, 2025

(30) Foreign Application Priority Data
Dec. 9, 2024 (FR) 2413650

(51) Int. Cl. G01G 19/07

(52) U.S. Cl. CPC G01G 19/07

(57) ABSTRACT

A method for surveillance of an estimate of the gross mass of an aircraft includes: obtaining or calculating a first estimate of the gross mass resulting from an addition of an estimate of a fuel onboard mass of the aircraft and a zero fuel mass estimate and an estimate of a fuel onboard mass of the aircraft; obtaining or calculating a second estimate of the gross mass of the aircraft using a first digital (aerodynamic) model of the aircraft; calculating for a calculation cycle of rank of a plurality of successive calculation cycles executed during a phase of acceleration of the aircraft when it takes off a third estimate of the gross mass using a second digital model of a different aircraft; and when a difference between the first and second estimates above a predetermined difference threshold validating one and invaliding the other as a function of the third estimate.

### TECHNICAL FIELD

The present invention concerns a method and system for surveillance of an estimate of the gross mass of an aircraft.

In everyday usage the term weight is often used to designate the mass of an object, although these are in fact different concepts (the weight P of an object corresponds to its mass m multiplied by the intensity of the gravitational field g at its location: P=m.g). For this reason and by an abuse of language the abbreviation GW (gross weight) is sometimes used in the remainder of the description to refer to the gross mass of the aircraft, although it strictly speaking refers to the gross weight of the aircraft.

Furthermore in the remainder of the description by “gross mass estimate” is meant the result of an estimation, that is to say an action aimed at determining the value of the gross mass.

### PRIOR ART

The mass of the aircraft is important for the calculation of characteristic speeds (read in the cockpit) and flight control laws.

At present a first estimate of the gross mass of the aircraft (denoted GWᵢₙᵢₜᵢₐₗ in the remainder of the description) is the result of adding an estimate of a mass of the aircraft without fuel, also known as the zero fuel mass (ZFW), and an estimate of the mass of fuel onboard the aircraft, also known as the FOB (fuel on board) mass. Thus GWᵢₙᵢₜᵢₐₗ=ZFW+FOB. The estimate of the zero fuel mass (ZFW) of the aircraft is entered by the crew of the aircraft into an FMS (flight management system). This input being manual, it is subject to errors. The estimate of the mass of fuel onboard the aircraft (FOB) is supplied by a fuel quantity and management system (FQMS).

A second estimate of the gross mass t of the aircraft (denoted GW_{AERO} in the remainder of the description) is based on a digital model which is an aerodynamic model of the aircraft typically having as input parameters: a speed, a pitch, an altitude, a configuration of the leading edge slats and trailing edge flaps, and an angle of attack (AOA) of the aircraft. This aerodynamic model is stored in an avionic computer of the aircraft, in particular a flight control computer, for example an FCGS (flight control and guidance system) or an FAC (flight augmentation computer) system.

At present the gross mass of the aircraft is monitored. The principle consists in comparing the first estimate GWᵢₙᵢₜᵢₐₗ with the second estimate GW_{AERO}. If any difference is detected (for example a difference exceeding several tonnes) the crew is alerted (by the display of a “CHECK GW” or “CHECK WEIGHT” message). As the avionics of the aircraft are not capable of determining which of the two estimates is incorrect the procedure recommended to the crew in the flight crew operating manual (FCOM) is to proceed to verification of the zero fuel mass (ZFW) of the aircraft entered beforehand by the crew into the FMS type system. If the zero fuel mass (ZFW) of the aircraft appears correct the operating manual indicates to the crew that they must consider whether the estimate GW_{AERO} is potentially erroneous and that in consequence some parameters calculated on board (by the FCGS or FAC type system) as a function of this estimate GW_{AERO}, notably the characteristics speeds displayed in the cockpit, are potentially erroneous and that they should not be taken into account. Considering that the estimate GW_{AERO} is potentially erroneous amounts to considering that there is an error in its calculation that can be imputed to a computer problem or to a problem (fault) in one or more probes (sensors) for acquisition of one or more input parameters (mainly the angle of attack) of the aerodynamic model used for the calculation.

Thus there exists a need to provide a solution that makes it possible to determine and to indicate to the crew which of the two estimates GWᵢₙᵢₜᵢₐₗ e or GW_{AERO} is erroneous if a difference between these two estimates is detected when monitoring the gross mass of the aircraft.

### STATEMENT OF INVENTION

There is proposed a method for surveillance of an estimate of the gross mass of an aircraft, the method being implemented by a system in the form of electronic circuitry, the method including:
obtaining or calculating a first estimate of the gross mass of the aircraft, resulting from an addition of an estimate of a zero fuel mass of the aircraft and an estimate of the mass of fuel onboard the aircraft;
obtaining or calculating a second estimate of the gross mass of the aircraft, using a first digital model of the aircraft that is an aerodynamic model of the aircraft having as input parameters at least the following parameters: a speed, a pitch, an altitude, a configuration of leading edge slat and trailing edge flap systems, and an angle of attack of the aircraft;
calculating, for a calculation cycle of rank i from a plurality of successive calculation cycles executed during a phase of acceleration when the aircraft takes off and as long as the aircraft is moving at a speed above a first predetermined speed threshold and below a second predetermined speed threshold itself greater than the first speed threshold, a third estimate of the gross mass of the aircraft using a second digital model of the aircraft different from the first digital model of the aircraft and having as input parameters at least the following parameters: a duration Δtr of each of the calculation cycles, a current ground speed GS(i), a thrust force TH(i), a drag force DF(i) and a lift force LF(i) on the aircraft in the calculation cycle of rank i, a take-off slope SL and a runway friction coefficient CR; and
in the event of a difference between the first and second estimates above a predetermined difference threshold validating one and invalidating the other of the first and second estimates as a function of the third estimate.

The third estimate of the gross mass of the aircraft (denoted GW_{T/O} in the remainder of the description) therefore makes it possible to determine (and therefore to indicate to the crew) which of the two estimates GWᵢₙᵢₜᵢₐₗ or GW_{AERO} is erroneous in the event that a difference between them is detected (when monitoring the gross mass of the aircraft). If the first estimate GWᵢₙᵢₜᵢₐₗ is validated and the second estimate GW_{AERO} is invalidated (erroneous) an alert can be issued to the crew (presence of a fault of the probes (sensors) or the computer falsifying the measurements displayed by the aircraft). Conversely, if the second estimate GW_{AERO} is validated and the first estimate GWᵢₙᵢₜᵢₐₗ is invalidated (erroneous) it is possible to validate the measurements displayed by the aircraft and to rule out a fault of the probes (sensors) or the computer.

In one particular embodiment after the speed of the aircraft has passed the second predetermined speed threshold during the acceleration phase when the aircraft takes off the third estimate is fixed and takes the value calculated in the last calculation cycle before the speed of the aircraft passed the predetermined second speed threshold.

In one particular embodiment the predetermined first speed threshold is between 25 knots and 35 knots and the predetermined second speed threshold is between 80 knots and 120 knots.

In one particular embodiment the third estimate is calculated in the calculation cycle of rank i as follows:

$$GW = \frac{Δ {D}_{r} ( i ) * [ ( TH ( i ) - DF ( i ) + ( CR * LF ( i ) ]}{[ Δ GS ( i ) * GS ( i ) ] + [ Δ {D}_{r} ( i ) * g ( CR + SL ) ]}$$

$$where$$

$$\begin{matrix}Δ {D}_{r} ( i ) = Δ {t}_{r} * GS ( i ) \\ Δ GS ( i ) = GS ( i ) - GS ( i - 1 )\end{matrix}$$

and g represents the acceleration due to terrestrial gravity, that is to say approximately 9.81 m/s².

In one particular embodiment the calculation of the third estimate uses for each of the input parameters GS(i), TH(i), DF(i) and LF(i) a mean value over the duration of the calculation cycle of rank i.

In one particular embodiment the thrust force TH(i) on the aircraft in the calculation cycle of rank i is calculated using a third digital model of the aircraft having as input parameters at least the following parameters:
at least one item of information relating to the thrust on the aircraft from the group comprising: a rotation speed N1 of a low-pressure system of each propulsion engine of the aircraft, an engine pressure ratio EPR and a throttle resolver angle TRA;
at least one item of information on the speed of the aircraft in the form a Mach number; and
at least two items of information on ambient conditions including a temperature item of information and a pressure item of information.

In one particular embodiment the drag force DF(i) and the lift force LF(i) on the aircraft in the calculation cycle of rank i are calculated using a fourth digital model of the aircraft having as input parameters at least the following parameters:
at least one item of information on the speed of the aircraft in the form of a Mach number;
at least two items of information on ambient conditions including a temperature item of information and a pressure item of information;
an item of information on the angle of attack of the aircraft; and
items of information relating to the current configuration of the leading edge slat and trailing edge flap systems of the aircraft.

There is also proposed a computer program product including instructions leading to the execution by a processor of any of the embodiments of the method referred to hereinabove when said instructions are executed by the processor.

There is also proposed a storage medium for storing such instructions.

There is also proposed a system for surveillance of an estimate of the gross mass of an aircraft, the system including electronic circuitry configured:
to obtain or to calculate a first estimate of the gross mass of the aircraft resulting from addition of an estimate of a zero fuel mass of the aircraft and an estimate of a fuel onboard mass in the aircraft;
to obtain or to calculate a second estimate of the gross mass of the aircraft using a first digital model of the aircraft that is an aerodynamic model of the aircraft having as input parameters at least the following parameters: a speed, a pitch, an altitude, a configuration of the leading edge slat and trailing edge flap systems, and an angle of attack of the aircraft;
to calculate, for a calculation cycle of rank i of a plurality of successive calculation cycles executed during a phase of acceleration of the aircraft when it takes off and as long as the aircraft is moving at a speed above a predetermined first speed threshold and below a predetermined second speed threshold itself greater than the first speed threshold, a third estimate of the gross mass of the aircraft using a second digital model of the aircraft different from the first digital model of the aircraft and having as input parameters at least the following parameters: a duration Δtr of each of the calculation cycles, a current ground speed GS(i), a thrust force TH(i), a drag force DF(i) and a lift force LF(i) on the aircraft in the calculation cycle of rank i; a take-off slope SL; and a runway friction coefficient CR; and
in the event of a difference between the first and second estimates above a predetermined difference threshold to validate one and to invalidate the other of the first and second estimates as a function of the third estimate.

There is also proposed an aircraft including a surveillance system as referred to hereinabove.

### BRIEF DESCRIPTION OF THE DRAWINGS

The features of the invention referred to hereinabove and others will become more clearly apparent on reading the following description of at least one embodiment, said description being given with reference to the appended drawings, in which:

FIG. 1 depicts diagrammatically in a view from the side an aircraft equipped with a system for surveillance of an estimate of the gross mass of an aircraft;

FIG. 2 depicts diagrammatically an example of an algorithm for surveillance of an estimate of the gross mass of an aircraft;

FIG. 3 depicts a particular implementation of the step of calculation of the third estimate GW_{T/O} of the FIG. 2 algorithm;

FIG. 4 depicts in the form of a block diagram one embodiment of the surveillance system seen in FIG. 1;

FIG. 5 depicts one particular implementation of the block for calculation of the third estimate GW_{T/O} in the FIG. 4 block diagram; and

FIG. 6 depicts diagrammatically one example of a hardware platform enabling implementation in the form of electronic circuitry of the system for surveillance of an estimate of the gross mass of an aircraft.

### DETAILED DESCRIPTION OF EMBODIMENTS

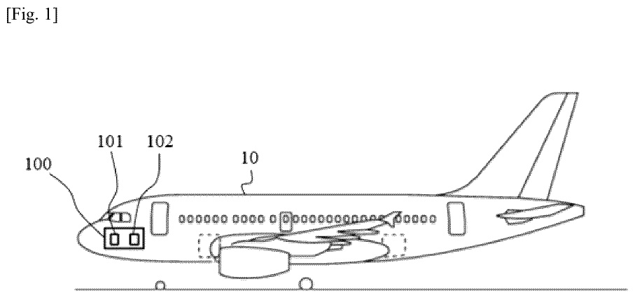

FIG. 1 depicts diagrammatically a side view an aircraft 10. The aircraft 10 includes a system 101 for surveillance of an estimate of the gross mass of the aircraft. The surveillance system 101 is implemented in the form of electronic circuitry and is typically integrated into an avionic system 100.

The surveillance system 101 is for example part of a flight control computer, for example an FCGS (flight control and guidance system) type system or an FAC (flight augmentation computer) type system.

The avionic system 100 typically also includes an FMS (flight management system) type system 102 and various other systems (not represented in FIG. 1) such as: an ADIRS (air data inertial reference system) type system, an FADEC (full authority digital engine control) type system, an FWS (flight warning system) type system, an EIS (electronic information system) type system notably including an ECAM (electronic centralized aircraft monitoring) type system, a CFDIU (centralized fault display interface unit) type system and an SFCC (slat flap control computer) type system. The avionic system 100 typically also includes other electronic systems.

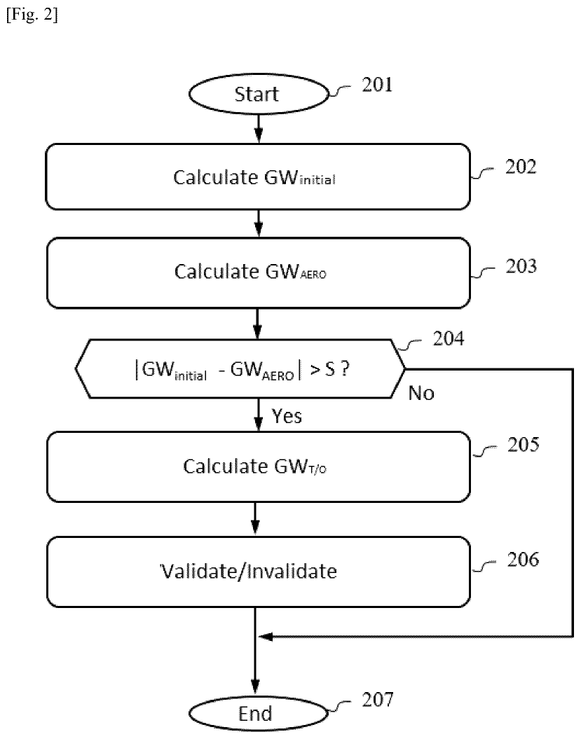

The surveillance system 101 implements a method (algorithm) for surveillance of an estimate of the gross mass of the aircraft. One particular embodiment of this method is diagrammatically depicted in FIG. 2.

In a step 202 (that follows on from an initiation step 201 of the algorithm) the surveillance system 101 obtains or calculates a first estimate of the gross mass of the aircraft denoted GWᵢₙᵢₜᵢₐₗ. As already described above with reference to the prior art this first estimate is the result of adding a zero fuel mass (ZFW) of the aircraft and an estimated fuel onboard (FOB) mass: GWᵢₙᵢₜᵢₐₗ=ZFW+FOB. If the surveillance system 101 obtains (and therefore does not itself calculate) the first estimate GWᵢₙᵢₜᵢₐₗ the latter is for example calculated by the FMS type system 102.

In a step 203 the surveillance system 101 obtains or calculates a second estimate of the gross mass of the aircraft denoted GW_{AERO}. As also already described above with reference to the prior art this second estimate is a function of a first digital model of the aircraft that is an aerodynamic model of the aircraft having as input parameters at least the following parameters: a speed, a pitch, an altitude and an angle of attack of the aircraft obtained for example from the ADIRS type system and a configuration of the leading edge slat and trailing edge flap devices obtained for example from the SFCC type system.

In a step 204 the surveillance system 101 verifies if a difference between the first and second estimates (denoted: |GWᵢₙᵢₜᵢₐₗ−GW_{AERO}|) is above a predetermined difference threshold S (204). In one particular implementation the threshold S is of the order of several tonnes. In the event of a positive response to the test in step 204 (a difference greater than S) the surveillance system 101 executes a step 205 and then a step 206 before proceeding to the final step 207 of the algorithm. If not (a difference less than or equal to S) the surveillance system 101 goes directly to the final step 207.

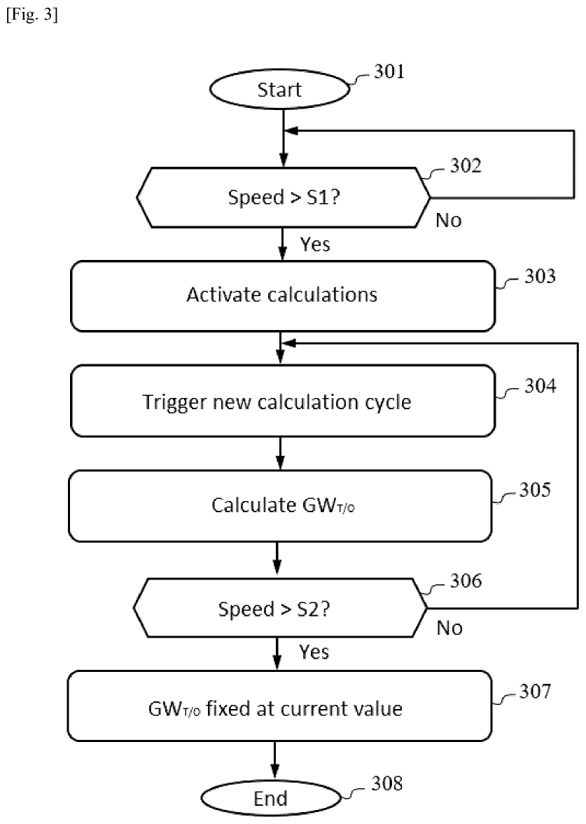

In the step 205 the surveillance system 101 calculates a third estimate of the gross mass of the aircraft denoted GW_{T/O} as a function of a second digital model of the aircraft different from the first digital model. The third estimate GW_{T/O} is independent of the second estimate GW_{AERO} because they are calculated using digital models of the aircraft that are based on different physical phenomena: lift equation for the aerodynamic model (first digital model) used to calculate the second estimate and inertia (to be more precise Newton's second law) for the second digital model used to calculate the third estimate. It must be remembered that Newton's second law (or fundamental principle of dynamics) states that a resultant force executed on an object is always equal to the product of the mass of that object by its acceleration and that the acceleration produced and the resultant force have the same orientation. The resultant force is the force equivalent to the vectorial sum of all the forces acting on the object. In the present context (and as explained in detail hereinafter) the forces acting on the object are the thrust, the lift, the drag, the runway friction and the weight of the aircraft. One particular embodiment of the step 205 is described hereinafter with reference to FIG. 3.

In the step 206 the surveillance system 101 validates one and invalidates the other of the first and second estimates (GWᵢₙᵢₜᵢₐₗ and GW_{AERO}) as a function of the third estimate (GW_{T/O}). For example the surveillance system 101 validates whichever of the first and second estimates is closest to the third estimate and invalidates the other one.

FIG. 3 depicts a particular implementation of the step 205 of calculating the third estimate GW_{T/O} in the FIG. 2 algorithm.

In a step 302 (which follows on from an initialisation step 301) the surveillance system 101 verifies if during a phase of acceleration when the aircraft takes off the aircraft has a speed V greater than a predetermined first speed threshold S1. In one particular implementation the first speed threshold S1 is between 25 and 35 knots (i.e. approximately between 46 kph and 65 kph) calibrated air speed (CAS). This avoids having to carry out resource greedy calculations during the initial take-off phase. If the first speed threshold S1 is reached (that is to say if V>S1) a step 303 is effected; if not the step 302 is repeated.

In the step 303 the surveillance system 101 activates calculations, more particularly of the third estimate GW_{T/O} of the gross mass of the aircraft, as described in detail hereinafter. The calculations are carried out through successive calculation cycles.

In a step 304 the surveillance system 101 triggers a new calculation cycle.

In a step 305 for a calculation cycle of rank i the surveillance system 101 calculates the third estimate GW_{T/O} as a function of a second digital model of the aircraft different from the first digital model of the aircraft (aerodynamic model used to calculate the second estimate GW_{AERO}). The second digital model has as input parameters at least the following parameters: a duration Δtᵣ of each of the calculation cycles, a current ground speed GS(i), a thrust force TH(i), a drag force DF(i) and a lift force LF(i) on the aircraft in the calculation cycle of rank i, a take-off slope SL and a runway friction coefficient CR.

In one particular implementation, for a calculation cycle of rank i, the third estimate is calculated using the following equation (1):

$$GW = \frac{Δ {D}_{r} ( i ) * [ ( TH ( i ) - DF ( i ) + ( CR * LF ( i ) ]}{[ Δ GS ( i ) * GS ( i ) ] + [ Δ {D}_{r} ( i ) * g ( CR + SL ) ]}$$

$$where$$

$$\begin{matrix}Δ {D}_{r} ( i ) = Δ {t}_{r} * GS ( i ) \\ Δ GS ( i ) = GS ( i ) - GS ( i - 1 )\end{matrix}$$

and g represents the acceleration due to terrestrial gravity, i.e. approximately 9.81 m/s².

The reasoning leading to this equation (1) is described in detail at the end of the present description.

For improved accuracy the calculation of the third estimate uses for each of the input parameters GS(i), TH(i), DF(i) and LF(i) a mean value over the duration of the calculation cycle of rank i concerned (for example a mean value of a value at the start of the calculation cycle and a value at the end of the calculation cycle) rather than considering only the value at the start of the calculation cycle. In effect, these parameters vary significantly between the start and the end of the calculation cycle (also referred to as the “time step”).

In one particular implementation the thrust force TH(i) of the aircraft in the calculation cycle of rank i is calculated using a third digital model of the aircraft having as input parameters at least the following parameters:
at least one item of information relating to the thrust of the aircraft (coming for example from the FADEC type system) from the group comprising: a rotation speed N1 of a low-pressure system of each propulsion engine of the aircraft, an engine pressure ratio (EPR) and a throttle resolver angle (TRA);
at least one item of information on the speed of the aircraft (coming for example from the ADIRS type system) in the form of a Mach number; and
at least two items of information on ambient conditions (coming for example from the ADIRS type system) including a temperature item of information and a pressure item of information.

In one particular embodiment the drag force DF(i) and the lift force LF(i) on the aircraft in the calculation cycle of rank i are calculated using a fourth digital model of the aircraft having as input parameters at least the following parameters:
at least one item of information on the speed of the aircraft (coming for example from the ADIRS type system) in the form of a Mach number;
at least two items of information on ambient conditions (coming for example from the ADIRS type system) including a temperature item of information and a pressure item of information;
an item of information on the angle of attack of the aircraft (coming for example from the ADIRS type system); and
items of information (coming for example from the SFCC type system) relating to the current configuration of the leading edge slat and trailing edge flap systems of the aircraft.

In a step 306 the surveillance system 101 verifies if during the acceleration phase when the aircraft is taking off the speed V of the aircraft exceeds a predetermined second speed threshold S2 greater than the first speed threshold S1. In one particular implementation the second speed threshold S2 is between 80 knots and 120 knots (i.e. between approximately 148 kph and 223 kph) calibrated air speed (CAS). If the second speed threshold S2 is exceeded (i.e. if V>S2) a step 307 is effected; if not the step 304 is repeated (triggering a new calculation cycle).

In the step 307 the surveillance system 101 sets the third estimate GW_{T/O} to the value calculated in the last calculation cycle before the speed of the aircraft exceeds the second speed threshold S2 (i.e. to the value calculated in the last iteration of the step 305).

This limits the calculation of the third estimate GW_{T/O} to the initial take-off phase when the speed is between the speed thresholds S1 and S2 in order to guarantee that the third estimate GW_{T/O} is independent of the second estimate GW_{AERO}. In effect the second estimate GW_{AERO} is obtained using the first digital model of the aircraft which is an aerodynamic model. Now aerodynamic effects are virtually negligible at low speed. The third estimate GW_{T/O} (using the second digital model of the aircraft different from the first digital model of the aircraft) is calculated when the aircraft is moving at a low speed (between S1 and S2), that is to say as long as the aerodynamic effects are negligible.

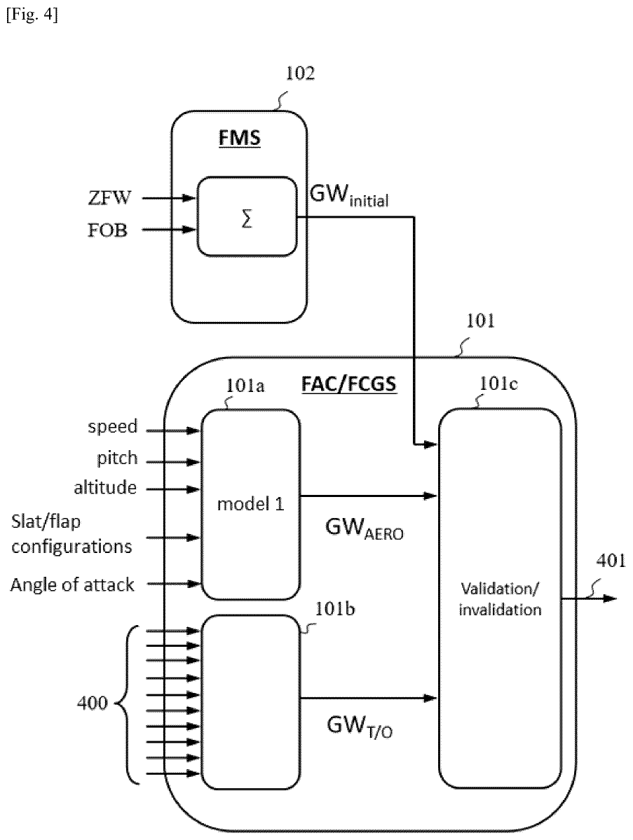

FIG. 4 depicts in the form of a block diagram (functional diagram) the surveillance system 101 seen in FIG. 1 in an embodiment comprising three functional blocks 101a, 101b and 101c implemented for example in the FCGS type system or the FAC type system.

The first functional block 101a is configured to calculate the second estimate GW_{AERO} of the gross mass of the aircraft using the first digital model of the aircraft (aerodynamic model) the input parameters of which have been described above (speed, pitch, altitude, angle of attack, configuration of leading edge slat system and trailing edge flap system).

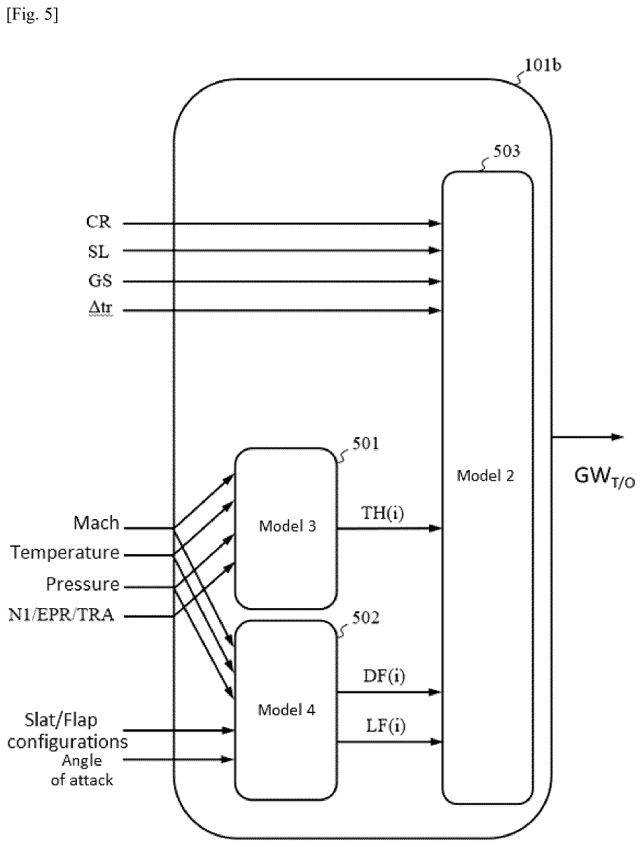

The second functional block 101b is configured to calculate the third estimate GW_{T/O} of the gross mass of the aircraft as a function of input parameters 400. This second functional block 101b is described in more detail hereinafter with reference to FIG. 5.

The third functional block 101c is configured to validate one and invalidate the other of the first and second estimates (GWᵢₙᵢₜᵢₐₗ and GW_{AERO}) as a function of the third estimate GW_{T/O} in the event of a difference between the first and second estimates above the predetermined difference threshold S. The first estimate GWᵢₙᵢₜᵢₐₗ is supplied by the FMS type system 102 which calculates it by adding the estimate of the zero fuel mass (ZFW) of the aircraft and the estimate of the fuel onboard (FOB) mass. The output 401 from the functional block 101c is an item of information intended in particular for the crew and specifying which estimate is validated and which estimate is invalidated.

FIG. 5 depicts a particular implementation of the second functional block 101b that calculates the third estimate GW_{T/O} and comprises three functional sub-blocks 501, 502 and 503.

The first functional sub-block 501 is configured to calculate in each calculation cycle of rank i the thrust force TH(i) on the aircraft using the third digital model of the aircraft the input parameters of which have been described above (item of information N1, EPR or TRA relating to the thrust of the aircraft, Mach number, temperature and pressure items of information).

The second functional sub-block 502 is configured to calculate in each calculation cycle of rank i the drag force DF(i) and the lift force LF(i) on the aircraft using the fourth digital model of the aircraft the input parameters of which have been described above (Mach number, temperature and pressure items of information, angle of attack of the aircraft item of information, items of information relating to the current configuration of the leading edge slat system and the trailing edge flap system).

The third functional sub-block 503 is configured to calculate (see the step 205 in FIG. 2 and the step 305 in FIG. 3) in each calculation cycle of rank i the third estimate GW_{T/O} using the second digital model of the aircraft the input parameters of which are: the thrust force TH(i) (supplied by the functional sub-block 501), the drag force DF(i) and the lift force LF(i) (supplied by the functional sub-block 502), the predetermined runway friction coefficient CR, the take-off slope SL (supplied for example by a TAWS (terrain avoidance and warning system) type system), the predetermined duration Δtᵣ of each of the calculation cycles, and the current ground speed GS(i) in the calculation cycle of rank i (supplied for example by the ADIRS type system).

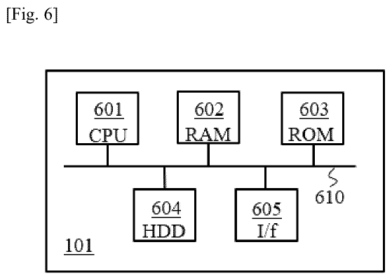

FIG. 6 depicts diagrammatically an example of a hardware platform enabling implementation in the form of electronic circuitry of the system 101 for surveillance of an estimate of the gross mass of the aircraft 10.

The hardware platform then includes, connected by a communication bus 610: a processor or CPU (central processing unit) 601; a RAM (random access memory) 602; a ROM (read only memory) or EEPROM (electrically-erasable programmable ROM) 603; a storage unit such as a hard disk drive (HDD) 604 or a storage medium reader such as an SD (secure digital) card reader; and an interface manager 605. The interface manager 605 enables the surveillance system 101 to interact with other equipment of the aircraft 10 and more with the avionics systems 100 of the aircraft 10.

The processor 601 is capable of executing instructions loaded into the random access memory 602 from the read only memory 303, an external memory (not represented), a storage medium (such as an SD card) or a communication network (not represented). When the hardware platform is powered up the processor 601 is able to read and to execute instructions from the random access memory 602. These instructions form a computer program causing execution by the processor 601 of some or all of the steps and operations described here.

Some or all of the steps and operations described here can therefore be implemented in software by execution of a set of instructions by a programmable machine, for example a DSP (digital signal processor) or a microcontroller, or implemented in hardware by a machine, a dedicated electronic component (chip) or a dedicated set of electronic components (chipset), for example an FPGA (field programmable gate array) or an ASIC (application specific integrated circuit). Generally speaking the surveillance system 101 includes electronic circuitry adapted and configured to implement the steps and operations described here.

### Reasoning Yielding the Aforementioned Equation (1)

During the take-off phase the aim is to model the dynamic of the aircraft on the same basis as expressed in the patent document FR3145217A1 considering that there is no degradation of performance. To this end it is assumed that two hypotheses are verified:
the take-off runway is not contaminated; and
no major anomaly has occurred during take-off, in other words the execution of the method described in the patent document FR3145217A1 has not triggered any alarm and aborting take-off has not been recommended to the crew.

The distance ΔDᵣ(i) really travelled by the aircraft during the calculation cycle of rank i during the take-off phase is expressed as follows:

$$Δ {D}_{r} ( i ) = Δ {t}_{r} * GS ( i )$$

where:
   Δtᵣ represents the (predetermined) duration of each of the calculation cycles; and
   GS(i) represents the current ground speed of the aircraft in the calculation cycle of rank i.

The distance ΔDₜ(i) theoretically travelled by the aircraft during the calculation cycle of rank i during the take-off phase is expressed as follows:

$$Δ {D}_{t} ( i ) = Δ {t}_{t} * GS ( i )$$

where:
   Δtₜ represents the time theoretically taken by the aircraft since the preceding calculation cycle (of rank i−1) to increase its ground speed to the current ground speed GS(i).

Newton's second law states that a resultant force F_{R} exerted on an object is always equal to the product of the mass m of that object by its acceleration a: F_{R}=m*a. In the present case Newton's second law can be written as follows:

$$\sum {F}_{n} ( i ) = GW * ( \frac{Δ GS ( i )}{Δ {t}_{t}} )$$

where:
   Σ Fₙ(i) represents an estimate of the resultant force exerted on the aircraft during the take-off phase (equivalent to the vectorial sum of all the forces acting on the aircraft);
   GW represents the gross mass of the aircraft (which is to be estimated); and
   ΔGS(i) represents the variation on the current ground speed of the aircraft since the preceding calculation cycle of rank i−1.

Starting from the preceding equation we can write:

$$Δ {t}_{t} = ( Δ GS ( i ) * GW ) / \sum {F}_{n} ( i )$$

Replacing Δtₜ by this expression in the equation for ΔDₜ(i) we obtain:

$$Δ {D}_{t} ( i ) = ( Δ GS ( i ) * GW / \sum {F}_{n} ( i ) ) * GS ( i )$$

In the present context:

$$\sum {F}_{n} ( i ) = TH ( i ) - DF ( i ) - ( SL * GW * g ) - [ CR * ( g . GW - LF ( i ) ) ]$$

where:
   TH(i) represents a thrust force on the aircraft during the calculation cycle of rank i;
   DF(i) represents a drag force on the aircraft during the calculation cycle of rank i;
   LF(i) represents a lift force on the aircraft during the calculation cycle of rank i;
   SL represents a take-off slope SL (expressed as a percentage);
   g represents the acceleration due to terrestrial gravity, i.e. approximately 9.81 m/s²; and
   CR represents a runway friction coefficient CR.

Replacing Σ Fₙ (i) by this expression in the equation ΔDₜ(i) we obtain:

$$Δ {D}_{t} ( i ) = \frac{Δ GS ( i ) * GW}{TH ( i ) - DF ( i ) - ( SL * GW * g ) - [ CR * ( g . GW * LF ( i ) ) ]} * GS ( i )$$

Considering that performance is not degraded (see hereinabove the corresponding two hypotheses) we can write:

$$Δ {D}_{r} ( i ) = Δ {D}_{t} ( i )$$

Starting from this equation, replacing ΔDₜ(i) with its expression developed hereinabove and isolating GW the aforementioned equation (1) is obtained giving the third estimate GW_{T/O} of the gross mass of the aircraft, that is to say:

$$GW = \frac{Δ {D}_{r} ( i ) * [ ( TH ( i ) - DF ( i ) + ( CR * LF ( i ) ]}{[ Δ GS ( i ) * GS ( i ) ] + [ Δ {D}_{r} ( i ) * g ( CR + SL ) ]}$$

1. A method for surveillance of an estimate of the gross mass of an aircraft, the method being implemented by a system in the form of electronic circuitry, the method including:
obtaining or calculating a first estimate of the gross mass of the aircraft (GWᵢₙᵢₜᵢₐₗ), resulting from an addition of an estimate of a zero fuel mass (ZFW) of the aircraft and an estimate of the mass of fuel onboard (FOB) the aircraft;
obtaining or calculating a second estimate of the gross mass of the aircraft (GW_{AERO}), using a first digital model of the aircraft that is an aerodynamic model of the aircraft having as input parameters at least the following parameters: a speed, a pitch, an altitude, a configuration of leading edge slat and trailing edge flap systems, and an angle of attack of the aircraft;
calculating, for a calculation cycle of rank i from a plurality of successive calculation cycles executed during a phase of acceleration when the aircraft takes off and as long as the aircraft is moving at a speed above a first predetermined speed threshold and below a second predetermined speed threshold itself greater than the first speed threshold, a third estimate of the gross mass of the aircraft (GW_{T/O}) using a second digital model of the aircraft different from the first digital model of the aircraft and having as input parameters at least the following parameters: a duration Δtr of each of the calculation cycles, a current ground speed GS(i), a thrust force TH(i), a drag force DF(i) and a lift force LF(i) on the aircraft in the calculation cycle of rank i, a take-off slope SL, and a runway friction coefficient CR; and
in the event of a difference between the first and second estimates above a predetermined difference threshold, validating one and invalidating the other of the first and second estimates as a function of the third estimate.

2. The method according to claim 1 in which, after the speed of the aircraft has passed the second predetermined speed threshold during the acceleration phase when the aircraft takes off, the third estimate is fixed and takes the value calculated in the last calculation cycle before the speed of the aircraft passed the predetermined second speed threshold.

3. The method according to claim 1 in which the predetermined first speed threshold is between 25 knots and 35 knots and the predetermined second speed threshold is between 80 knots and 120 knots.

4. The method according to claim 1 in which the third estimate is calculated in the calculation cycle of rank i as follows:
$$GW = \frac{Δ {D}_{r} ( i ) * [ ( TH ( i ) - DF ( i ) + ( CR * LF ( i ) ]}{[ Δ GS ( i ) * GS ( i ) ] + [ Δ {D}_{r} ( i ) * g ( CR + SL ) ]}$$
$$where$$
$$\begin{matrix}Δ {D}_{r} ( i ) = Δ {t}_{r} * GS ( i ) \\ Δ GS ( i ) = GS ( i ) - GS ( i - 1 )\end{matrix}$$
and g represents the acceleration due to terrestrial gravity, that is to say approximately 9.81 m/s².

5. The method according to claim 1 in which the calculation of the third estimate uses for each of the input parameters GS(i), TH(i), DF(i) and LF(i) a mean value over the duration of the calculation cycle of rank i.

6. The method according to claim 1 in which the thrust force TH(i) on the aircraft in the calculation cycle of rank i is calculated using a third digital model of the aircraft having as input parameters at least the following parameters:
at least one item of information relating to the thrust on the aircraft from the group comprising: a rotation speed N1 of a low-pressure system of each propulsion engine of the aircraft, an engine pressure ratio EPR and a throttle resolver angle TRA;
at least one item of information on the speed of the aircraft in the form a Mach number; and
at least two items of information on ambient conditions including a temperature item of information and a pressure item of information.

7. The method according to claim 1 in which the drag force DF(i) and the lift force LF(i) on the aircraft in the calculation cycle of rank i are calculated using a fourth digital model of the aircraft having as input parameters at least the following parameters:
at least one item of information on the speed of the aircraft in the form of a Mach number;
at least two items of information on ambient conditions including a temperature item of information and a pressure item of information;
an item of information on the angle of attack of the aircraft; and
items of information relating to the current configuration of the leading edge slat and trailing edge flap systems of the aircraft.

8. (canceled)

9. A non-transitory storage medium for storing a computer program including instructions leading to the execution by the processor of the method according to claim 1 when said instructions are read and executed by the processor.

10. A system for surveillance of an estimate of the gross mass of an aircraft, the system including electronic circuitry configured:
to obtain or to calculate a first estimate of the gross mass of the aircraft (GWᵢₙᵢₜᵢₐₗ) resulting from addition of an estimate of a zero fuel mass (ZFW) of the aircraft and an estimate of a fuel onboard (FOB) mass in the aircraft;
to obtain or to calculate a second estimate of the gross mass of the aircraft (GW_{AERO}) using a first digital model of the aircraft that is an aerodynamic model of the aircraft having as input parameters at least the following parameters: a speed, a pitch, an altitude, a configuration of the leading edge slat and trailing edge flap systems, and an angle of attack of the aircraft;
to calculate, for a calculation cycle of rank i of a plurality of successive calculation cycles executed during a phase of acceleration of the aircraft when it takes off and as long as the aircraft is moving at a speed above a predetermined first speed threshold and below a predetermined second speed threshold itself greater than the first speed threshold, a third estimate of the gross mass of the aircraft (GW_{T/O}) using a second digital model of the aircraft different from the first digital model of the aircraft and having as input parameters at least the following parameters: a duration Δtr of each of the calculation cycles, a current ground speed GS(i), a thrust force TH(i), a drag force DF(i) and a lift force LF(i) on the aircraft in the calculation cycle of rank i, a take-off slope SL and a runway friction coefficient CR; and
in the event of a difference between the first and second estimates above a predetermined difference threshold to validate one and to invalidate the other of the first and second estimates as a function of the third estimate.

11. An aircraft including a surveillance system according to claim 10.
